(19) United States
(12) Patent Application Publication
(10) Pub. No.: US 2013/0031392 A1
(43) Pub. Date: Jan. 31, 2013

(54) USB DEVICE SIDE WAKE-UP FOR POWER CONSERVATION AND MANAGEMENT

(71) Applicant: William J. McLane, Greendale, WI (US)

(72) Inventor: William J. McLane, Greendale, WI (US)

(21) Appl. No.: 13/194,249

(22) Filed: Jul. 29, 2011

(51) Int. Cl. G06F 1/32

(52) U.S. Cl. 713/323

(57) ABSTRACT

In a system in which a host device is in communication with a peripheral device through communications device connected to a USB port, the USB host device polls the communications device to constantly regardless of the power state of the USB communications device. While in the low power mode, the USB communications device generates NAK packets, indicating that the device has no data to send. The NAK packets are generated in hardware, thereby allowing the USB host continues operating while unaware of the state of the peripheral device. External events can be used to trigger the USB communications device to exit the low power state without communicating with the USB host, and without the USB host altering its behavior.

### BACKGROUND

In recent years, the Universal Serial Bus (USB) has become an increasingly common means for communicating between computers, mobile devices, and peripheral devices. The USB port, for example, is frequently used to provide standardized communications, interconnecting computers with peripheral devices, including printers, keyboards, and scanners. Adapters are also available for connecting computerized devices to wired local area networks (LANs) through the USB port. As wireless networks have become increasingly popular, interface devices that adapt the USB port for wireless communications, including Bluetooth, wireless local area networks (WLAN) and other I.E.E.E. 802.11 communication standards, have also become commonplace. The uses for the USB port, therefore, have dramatically increased in recent years.

Although USB devices have many applications, however, the power supplied from a USB port is limited to 5V at 500 mA. To minimize power consumption, therefore, standard USB wireless devices support both a normal mode of operation, and a low power sleep or standby mode. Once a device enters a sleep mode, some devices can be returned to normal mode using a “remote wakeup” feature that is defined by the USB specification (USB 2.0 specification section 9.1.1.6). This feature, however, is optional, and is therefore not supported by all devices, and is not supported by all hosts. In systems that do not support this feature, when the USB wireless device enters the low power sleep or standby mode, to conserve power, the USB wireless device does not recognize connection requests. The device stays in the lower power mode until the user wakes up the USB wireless device through the USB host system, using a wake up call from the USB host system that is transmitted through the USB hardwired interface. The need for a wake-up call, however, is inconvenient for users of wireless devices, who prefer to have their wireless devices active at all times. During typical operation, therefore, wireless devices are not operated in the “sleep” or low power mode. While limiting inconvenience to the user, however, maintaining the device in normal operation mode is inefficient in terms of power usage and reliability. To optimize user convenience, and conserve power, it is desirable to consider power while maintaining the device in an active state.

In typical USB operation, moreover, USB communications are controlled by the USB host. The host USB device decides when a peripheral needs to enter a low power mode, and sends a signal forcing the device into that mode. The host then stops issuing data requests until a resume code is sent to wake up the communications device. The USB communication are therefore controlled completely by the USB host, and a device in communication with the host cannot push data to the host, but rather can only send data is when a host requests it. It is also desirable to keep USB peripherals active, and to allow a wireless communication device to make its own determinations as to when to communicate with a host. The present invention addresses these and other issues.

### SUMMARY

In one aspect, the invention comprises a communications adapter. The communications adapter includes a universal serial bus interface adapted to be in communication with a host device, a wireless communications device adapted to be in communication with a peripheral device, and a processor coupled to the universal serial bus interface, and including a peripheral controller in communication with the wireless communications device. The processor is programmed to determine a time that the wireless communications device has been inactive, and, when the time exceeds a predetermines threshold, to deactivate the peripheral controller, slow the internal clock to enter a low power sleep mode, map the peripheral controllers to interface lines, and transmit a negative acknowledgement code on the universal serial bus. When the wireless communication device detects a connection request, re-activating the peripheral controllers, and increasing the clock speed, wherein a connected host device is unaware of the low power state of the communications adapter.

The processor of the communications adapter can include a hardware component for transmitting the negative acknowledgement code packet. The processor can be configured to include an interrupt IN endpoint and a Bulk IN/OUT endpoint.

In another aspect of the invention, the communication adapter can include a random access memory in communication with the processor, the processor can be programmed to enter a suspended to RAM state.

In another aspect of the invention, a communications system is provided comprising a universal serial bus (USB) host device, a peripheral computing device, and a communications adapter. The communications adapter includes a processor connected in communication with the USB host device through a USB interface, and with the peripheral computing device through a communications device. The processor in the communications adapter is programmed to determine a time that the communications device has been inactive, and, when the time exceeds a predetermines threshold, to deactivate the peripheral controller and map the input lines to the peripheral controller to interrupt lines, slow the internal clock to enter a low power sleep mode, and transmit a negative acknowledgement code packet on the universal serial bus, indicating that the communication device is in a normal operating mode when the communication device is in a low power operating state. When the communication device detects a connection request, the processor re-activates the peripheral controllers, and increases the clock speed, wherein a connected host device is unaware that the communications adapter entered the low power state.

The USB host device can be a printer, and can be programmed to interpret the negative acknowledgement code as indicating there is no data to be transmitted at this time. The peripheral computing device can be at least one of a computer or a mobile telephone. The communication adapter can includes at least one of a LAN communication device, a Bluetooth communication device, and a WLAN communication device.

The processor can include a hardware component for transmitting the negative acknowledgement code packet. The USB interface of the processor can be configured to include an interrupt IN endpoint, and a Bulk IN/OUT endpoint.

The communication system can include a random access memory in communication with the processor, and the processor can be further programmed to enter a suspended to RAM state when entering the low power mode.

In another aspect of the invention, a method for minimizing a power consumption of a USB peripheral device in communication with a USB host device is provided, in a system in which the peripheral device comprises a processor that includes at least one peripheral controller for communicating with an external peripheral device. The method comprises the steps of operating the USB peripheral device in a normal mode wherein the USB host polls the peripheral device and the peripheral device sends a response packet to the USB host when it has data to send, monitoring a time period that the USB peripheral device is inactive, and, when the time period exceeds a predetermined threshold, putting the peripheral device into a low power mode. The system puts the peripheral device in the low power mode by deactivating the peripheral controller coupled to the processor in the USB peripheral device, and mapping the input lines to the peripheral controller to interrupt lines; slowing the internal clock of the processor to enter a low power sleep mode; and transmitting a negative acknowledgement code packet on the universal serial bus, providing a signal to the USB host that the USB peripheral is in a normal operating mode when the USB peripheral is in a low power operating state. When the wireless communication device detects a connection request, the interrupt line is activated, re-activating the peripheral controllers, and increasing the clock speed to return to a normal mode of operation. The peripheral USB device can comprise a communications adapter for translating communications between a protocol used by the external peripheral device and the USB protocol used by the USB host device.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a wireless communication device constructed in accordance with the present invention with a top cover exposed;

FIG. 2 is an exploded view of a wireless communications device constructed in accordance with the present invention;

FIG. 3 is a block diagram of one embodiment of a circuit card that can be used in FIG. 2.

FIG. 4 is a flow chart illustrating the modes of operation of the wireless communications device of the present invention, and the flow for moving between modes of operation.

### DETAILED DESCRIPTION

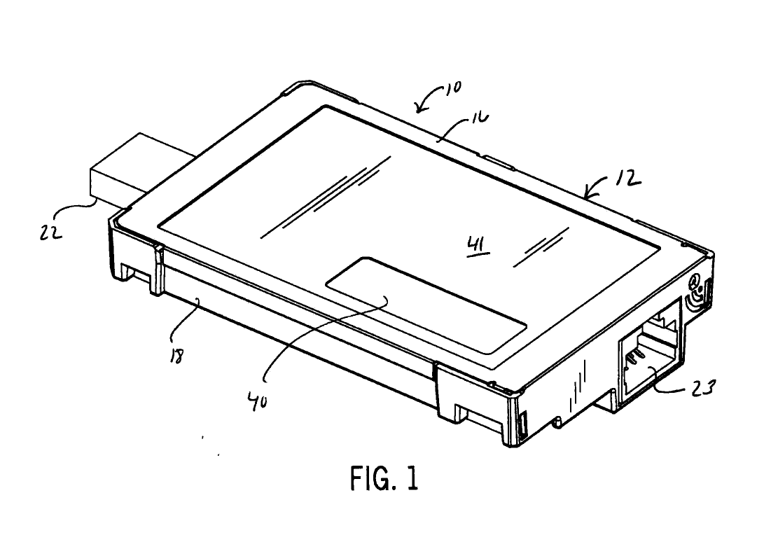

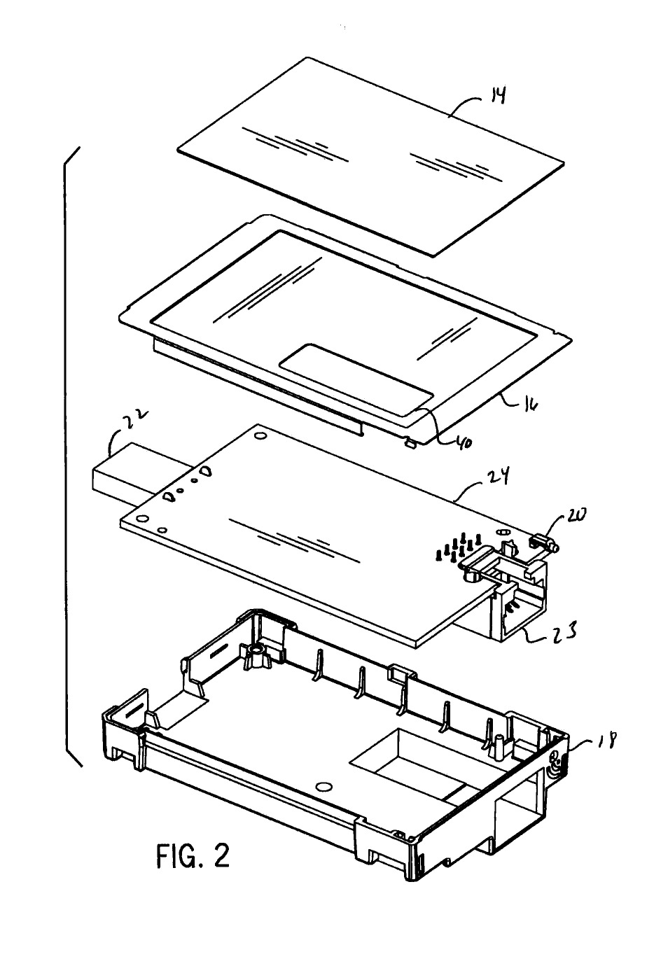

Referring now to the figures and more particularly to FIGS. 1 and 2, a communications adapter device 10 includes a housing 12 comprising a top cover 16 and a lower base member 18. A communications board 24 is provided between the top 16 and bottom 18 sections of the housing 12, and a label 14 is positioned on the top cover 16. A receptacle 22 for connection to an external device can be provided at one end of the communications adapter device 10. Here, the receptacle 22 is shown as a Universal Serial Bus (USB) type A connector. Various other types of connectors can also be used. The cover 16 can comprise a metal material, which is preferably stainless steel, while the bottom 11 comprises a material that allows transmissions from the antenna with limited interference, such as plastic. An aperture 40 can be provided in the cover 16 to limit interference with transmissions from the antenna. Other constructions, such as a plastic housing 12, can also be used.

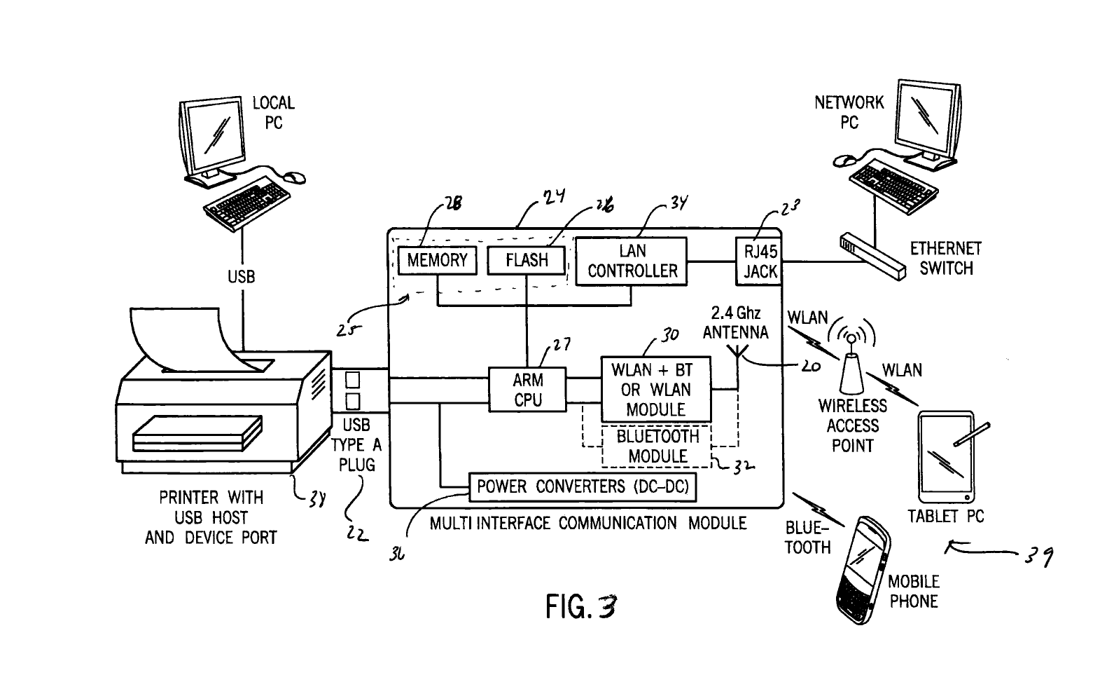

Referring now to FIG. 3, a block diagram of one embodiment of a wireless communications board that can be used with the housing 12 is shown. Here, the receptacle 22 is connected to the communications board 24, and can be connected, for example, to a universal serial bus (USB) port on an external USB host device 38. The communications board 24 includes a processor 27, such as a microprocessor, microcontroller, or other device, that is programmed to process communications received between the external device 38 on the USB port, and one or more wired or wireless communication devices for communicating with peripheral devices. The USB interface of the controller 27 is configured in software to include at least one Interrupt IN endpoint through which a USB Host, such as USB host device 38, will poll the device 10, and one or more Bulk IN/OUT endpoint pairs for higher speed data transfer, as defined in USB 2.0 specification section 8.4.5.

The wireless communication devices on communication board 24 can include, as shown here, a WLAN communication device 30, Bluetooth device 32 or other wireless communications devices operating to provide other wireless protocols including Zigbee, 3G, 4G, IEEE 802.11, etc. The processor 27 can also communicate through a communication device to a network through a local area network or wide area network connector, such as Ethernet Communications device 34, which can be connected to an RJ 45 connector 23 as shown here. In addition to the processor 27, a memory component 25 comprising, for example, a flash 26 and a RAM memory 28, which can be, for example, a synchronous dynamic random-access memory (SDRAM). Although specific type of memory is shown here, various types of memory components suitable for this application will be apparent to those of ordinary skill in the art including Read Only Memory (ROM), Electronically Programmable Read Only Memory (EPROM), Erasable Electronically Programmable Read Only Memory (EEPROM), etc. Although a number of different processors could be used in this application, the microcontroller is preferably an ARM microcontroller with integrated peripheral controllers, including, for example, a Synchronous dynamic random access memory (SDRAM) controller, Flash controller, and static random-access memory (SRAM) controller. The processor also can include serial interfaces, including universal serial bus (USB), Secure Digital Input Output (SDIO), universal asynchronous receiver transmitter (UART), serial digital interface (SDI), and Inter-Integrated Circuit (I2C). The USB interface can include hardware for producing negative acknowledgement codes. One example of a device providing this function is the NXP LPC3130 available from NXP Semiconductors N.V., Eindhoven, The Netherlands.

Referring still to FIG. 3, the USB connection to receptacle 22 provides power for operating the communications board 24 through the DC to DC convertor 36, and the processor 27 transmits information bi-directionally between external devices communicating through the communications devices 30, 32, 34 to the connected peripheral device 38. Communications to the communications card 24 from peripheral devices 39 can be, as shown here, from a networked PC, a tablet PC, or a mobile phone, for example, although any device capable of communication with the communication board 24 can be used. Although the wireless communication board 24 can be connected to various devices, in the embodiment shown here, the connected host device 38 is a printer. Computers, cellular phones, personal digital assistants, and other electronic devices, however, can be connected.

Referring still to FIG. 3, the main memory 28 can store instructions used to execute the operating system, as well as executable software for the communication module application. The memory 28 can also store temporary processes and variables, raw print job data extracted from the Bluetooth 32, WLAN 30 and LAN 34 interfaces during operation through, for example, a Dynamic RAM bus interface with the processor 27.

Referring still to FIG. 3, the Flash memory provides permanent storage for storing the board support package, a boot loader, an operating system kernel, firmware drivers and application software for the communication module. The processor 27 can, for example, boot up from the flash memory 26. The flash memory 26 can also include a backup boot image that can be retrieved to safely re-boot the system when there is a boot failure due to, for example, a boot loader corruption. The flash can be connected with the processor 27 on a Static RAM interface.

Referring yet again to FIG. 3, the LAN controller 34 can be a non Peripheral Component Interconnect (PCI) LAN controller that includes both integrated physical and Media Access Control (MAC) layers. It is connected with the MCU's Static RAM interface. When configured in this way, the LAN controller 34 can support 10/100 Mbps transfer rate and support multiple power modes.

Referring still to FIG. 3, the WLAN module 30 can be a highly integrated System In Package (SIP) unit, which comprises a wireless MAC base band controller (I.E.E.E. 802.11b/g/n Platform for Internet Content Selection (PICS) compliant), RF power amplifier, clock oscillators, DC-DC converters and RF transceivers. It can also support IEEE 802.11d, e, h, I, k, r, s PICS. It can also support the Bluetooth co-existence. It can be connected with a SDIO peripheral interface controller with the processor 27. The Bluetooth module 32 can also be a highly integrated standalone unit which consists of a Bluetooth base band controller, transceiver and clock oscillators. The Bluetooth module 32 can communicate with the processor 27 through a Universal Asynchronous Receiver Transmitter (UART) interface, and can support Bluetooth version 2.1+EDR standard. As shown here, optionally the Bluetooth module can be integrated with WLAN module 30 as a single package. In that case, the UART interface from the main MCU is shared between these two different Bluetooth modules.

Referring again to FIGS. 1 and 2, the top cover 16 of the wireless communications device 10 can include an aperture 40 that can be positioned adjacent the antenna 20, and can be oriented one to three length to width with respect to the antenna 20. The antenna 20 is preferably a microstrip or multilayer chip antenna, although other types of antennas can also be used. In one embodiment of the invention a AT8010-E2R9HAA antenna was shown to be advantageous. This device is available from Advanced Ceramic X Corp., Tzuchieng Road, Shinchu Industrial District, Shinchu, Hsien 303, Taiwan. The antenna can be a 2.4 GHz antenna which operates in the Industrial Scientific Medical (ISM) band and can be used with WLAN, Bluetooth, and other types of communication devices including these described above.

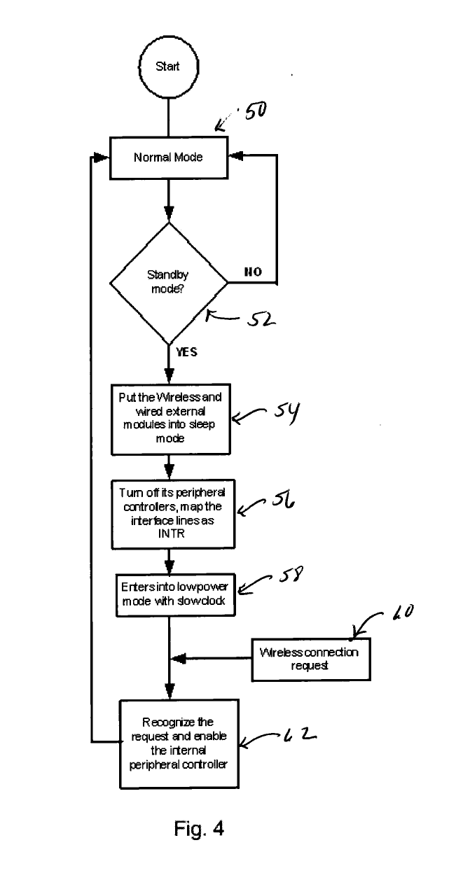

Referring still to FIG. 3, the host device 38 and communication device 10 are programmed to treat an NAK packet as an indication that there is no data at this time. Referring now to FIG. 4, which illustrate the process steps for switching between low power and normal operating modes in the normal operation mode 50 (e.g. when the communication device 10 has data to process and send to the USB host device 38), the controller 27 is maintained in an idle mode, with all of the peripheral interfaces active. When the host device 38 polls the communication card 24, the controller 27 sends a response packet to the host device 38 indicating it has data to send. The host device 38 then reads the data from the communication card 24. The data is stored in memory 25, and can be in RAM 28, flash memory 26, or both. In a specific example, when the host device 38 is a printer, the communication card 24 can include expanded storage for spooling print jobs. Here, the a print job could be saved to flash memory 26, while the card continues to handle (and save) additional print jobs as it waits for the printer 38 to read the data. Alternatively, a communications card 24 without expanded storage could buffer portions of a print job in RAM 28 for sequential transfer to the printer as it is received from a source.

Referring still to FIGS. 3 and 4, during operation, the controller 27 continually monitors inactive time, and when the communication adapter device 10 has been inactive for a selected amount of time controller 27 determines whether to put the communication adapter device 10 into a standby mode (step 52). If the selected time has not been exceeded, the controller maintains the device in the normal mode (step 50). In a printer application, the time period can be optimized based on the time period between successive print jobs, and the amount of time that is necessary to bring the communications device 10 back to a normal state. A time frame of 5 seconds of inactivity has been found to be effective, where a 1 second time frame was necessary to wake up the communications adapter device 10.

Referring still to FIG. 4, when the selected time has been exceeded, the controller 27 puts the wired and wireless communication devices 30, 32, and 34 into low power or sleep mode (Step 54). The controller 27 maps the standard interface lines corresponding to the peripheral controllers to interrupt lines, and is also “suspended to RAM.” In the “suspended to RAM” state, the current state of the kernel and the running applications of controller 27 are saved into RAM 28, and the RAM is placed into “self-refresh” mode which further increases the power savings kernel. The controller 27 then turns off the peripheral controllers or interfaces, including the SDIO, UART, and communications through USB connection to the host 38 through receptacle 22 (step 56). The controller then deactivates internal clocks, and enters into a low power mode. (step 58)

The host device 38 continues to poll the wireless communication device 10, but the communications device 10 now responds with negative acknowledgement codes (NAK packets), which are a standard part of the USB specification (USB 2.0 specification section 8.4.5), and which are used to communicate to a host device 38 that the communication device 10 has no data to send. The NAK packets are generated in hardware dedicated to the USB interface within the controller 27. When the software operating on controller 27 toggles a bit in a dedicated “NAK enable” register, the hardware will generate the NAK packet. The hardware enables the NAK packets to be generated when the controller is suspended and the internal clocks are disabled, including the clock to the USB hardware. The USB host 38 does not see any change in behavior from the device.

When an external device sends a wireless connection request to the wireless communication device 10 by, for example, attempting a Bluetooth connection (step 60) through the UART or SDIO interface, the peripheral interfaces on the controller 27 in communication device 10 can trigger an interrupt on the controller 27, which will bring the controller out of the suspend to RAM state. When the controller wakes up the stored current state is retrieved from the RAM 28, and operation continues from where it left off, which shortens wakeup time. The controller 27 also wakes up the selected UART or SDIO controller to receive the command and data. (step 62). While the communication device 10 is returning from the idle state, the USB hardware continues to respond to the USB host 38 with NAK packets. Once the microcontroller 27 has returned from the idle state, it returns to the normal mode 50 and processes the communication. Because the host device 38 has been programmed to interpret the NAK packet as an indication that there is no data at this time, the host 38 behaves as if the communication device 10 remained active throughout. Therefore, the logic necessary for entering the idle state is contained almost entirely on the communication device 10, and minimal logic is implemented on the host device 38.

It should be understood that the methods and apparatuses described above are only exemplary and do not limit the scope of the invention, and that various modifications could be made by those skilled in the art that would fall under the scope of the invention. For example, although the peripheral controllers are described as part of the processor, these controllers could be provided as separate components. Various other modifications will be apparent to those of skill in the art. To apprise the public of the scope of this invention, the following claims are made:

We claim:

1. A communications adapter comprising:
a universal serial bus interface adapted to be in communication with a host device;
a wireless communications device adapted to be in communication with a peripheral device;
a processor coupled to the universal serial bus interface, and including a peripheral controller in communication with the wireless communications device, the processor being programmed to:
determine a time that the wireless communications device has been inactive;
when the time exceeds a predetermines threshold,
(a) deactivate the peripheral controller and map the input lines to the peripheral controller to interrupt lines;
(b) slow the internal clock to enter a low power sleep mode; and
(c) transmit a negative acknowledgement code packet on the universal serial bus, indicating that the communication device is in a normal operating mode when the communication device is in a low power operating state; and
when the wireless communication device detects a connection request, re-activating the peripheral controllers, and increasing the clock speed, wherein a connected host device is unaware of the low power state of the communications adapter.

2. The communications adapter of claim 1, wherein the processor includes a hardware component for transmitting the negative acknowledgement code packet.

3. The communications adapter of claim 1, wherein the USB interface of the processor is configured to include an interrupt IN endpoint.

4. The communication adapter of claim 1, wherein the USB interface of the processor is configured to include a Bulk IN/OUT endpoint.

5. The communication adapter of claim 1, further comprising a random access memory in communication with the processor, and wherein the processor is further programmed to enter a suspended to RAM state before step (b).

6. A communications system comprising:
a universal serial bus (USB) host device;
a peripheral computing device; and
a communications adapter, including a processor connected in communication with the USB host device through a USB interface, and with the peripheral computing device through a communications device, the processor in the communications adapter being programmed to: determine a time that the communications device has been inactive, and when the time exceeds a predetermines threshold, to:
(a) deactivate the peripheral controller and map the input lines to the peripheral controller to interrupt lines;
(b) slow the internal clock to enter a low power sleep mode; and
(c) transmit a negative acknowledgement code packet on the universal serial bus, indicating that the communication device is in a normal operating mode when the communication device is in a low power operating state; and
when the communication device detects a connection request, re-activating the peripheral controllers, and increasing the clock speed, wherein a connected host device is unaware of the low power state of the communications adapter.

7. The communication system of claim 6, wherein the USB host device is programmed to interpret the negative acknowledgement code as indicating there is no data to be transmitted at this time.

8. The communication system of claim 6, wherein the USB host device is a printer.

9. The communication system of claim 6, wherein the wireless peripheral device is at least one of a computer or a mobile telephone.

10. The communication system of claim 6, wherein the communication device includes at least one of a LAN communication device, a Bluetooth communication device, and a WLAN communication device.

11. The communication system of claim 6, wherein the processor includes a hardware component for transmitting the negative acknowledgement code packet.

12. The communication system of claim 6, wherein the USB interface of the processor is configured to include an interrupt IN endpoint.

13. The communication system of claim 6, wherein the USB interface of the processor is configured to include a Bulk IN/OUT endpoint.

14. The communication system of claim 6, further comprising a random access memory in communication with the processor, and wherein the processor is further programmed to enter a suspended to RAM state before step (b).

15. A method for minimizing a power consumption of a USB peripheral device in communication with a USB host device, wherein the peripheral device comprises a processor that includes at least one peripheral controller for communicating with an external peripheral device, the method comprising the following steps:
operating the USB peripheral device in a normal mode wherein the USB host polls the peripheral device and the peripheral device sends a response packet to the USB host when it has data to send;
monitoring a time period that the USB peripheral device is inactive;
when the time period exceeds a predetermined threshold, taking the following steps to put the peripheral device in a low power mode:
(a) deactivating the peripheral controller coupled to the processor in the USB peripheral device, and mapping the input lines to the peripheral controller to interrupt lines;
(b) slowing the internal clock of the processor to enter a low power sleep mode; and
(c) transmit a negative acknowledgement code packet on the universal serial bus, providing a signal to the USB host that the USB peripheral is in a normal operating mode when the USB peripheral is in a low power operating state; and
when the wireless communication device detects a connection request, activating an interrupt line, re-activating the peripheral controllers, and increasing the clock speed to return to a normal mode of operation.

16. The method of claim 15, wherein the peripheral USB device comprises a communications adapter for translating communications between a protocol used by the external peripheral device and the USB protocol used by the USB host device.

17. The method of claim 15, wherein the processor produces the negative acknowledge code packet in hardware.

18. The method of claim 15, wherein step (b) further comprises the step of causing the processor to enter a suspended to RAM state before step (b).

19. The method of claim 15, further comprising the step of causing the host USB device to interpret the negative acknowledgement code as indicating there is no data to be transmitted at this time.

20. The method of claim 15, wherein the processor is configured to include an interrupt IN endpoint and a Bulk IN/OUT endpoint.
